(19) United States
(12) Patent Application Publication
(10) Pub. No.: US 2026/0051968 A1
(43) Pub. Date: Feb. 19, 2026

(54) TRANSMISSION STATION AND RECEIVING STATION THAT SWITCH BETWEEN OTFS MODULATION AND OFDM MODULATION

(71) Applicant: KDDI CORPORATION, Tokyo (JP)

(72) Inventors: Sango KANA, Fujimino-shi (JP); Noboru OOSAWA, Fujimino-shi (JP)

(21) Appl. No.: 19/325,391

(22) Filed: Sep. 10, 2025

Related U.S. Application Data
(63) Continuation of application No. PCT/JP2024/002337, filed on Jan. 26, 2024.

(30) Foreign Application Priority Data
Mar. 14, 2023 (JP) 2023-039937

(51) Int. Cl. H04L 1/00; H04L 5/00; H04W 56/00; H04W 64/00

(52) U.S. Cl. CPC H04L 1/0003; H04L 5/0051; H04W 56/0015; H04W 64/006

(57) ABSTRACT

A transmission station that performs wireless communication with a receiving station at a predetermined carrier frequency performs orthogonal frequency division multiplexing on a symbol sequence, performs orthogonal time frequency space multiplexing on a symbol sequence, performs switching between orthogonal frequency division multiplexing and orthogonal time frequency space multiplexing to input a symbol sequence obtained by mapping a bitstream to only one of them, obtains a relative velocity between the transmission station and a receiving station, controls the switching based on a velocity; and transmits a switching notification that is a control signal to the receiving station, when the switching is controlled.

### CROSS-REFERENCE TO RELATED APPLICATION(S)

This application is a continuation of International Patent Application No. PCT/JP2024/002337 filed on Jan. 26, 2024, which claims priority to and the benefit of Japanese Patent Application No. 2023-039937 filed on Mar. 14, 2023, the entire disclosures of which are incorporated herein by reference.

### BACKGROUND OF THE INVENTION

### Field of the Invention

The present invention relates to a technique of orthogonal time frequency space (OTFS) modulation.

### Description of the Related Art

There is a phenomenon in which, when there is a relative velocity between a transmission station and a receiving station, radio waves are received at a frequency different from the actual frequency of the radio waves. This phenomenon is commonly called the Doppler effect. Due to the Doppler effect, the more the transmission station and the receiving station approach each other at a high velocity, the more compressed the radio waves become, resulting in an increase in frequency, and, conversely, the more the transmission station and the receiving station separate away from each other at a high velocity, the more stretched the radio waves become, resulting in a decrease in frequency.

Orthogonal time frequency space (OTFS) modulation is a technique for mitigating the influence of the Doppler effect in communication. OTFS modulation refers to a technique in which information symbols are mapped to resource elements in a delay-Doppler domain and are converted into time-frequency domain signals through inverse symplectic fast Fourier transform (ISFFT). To implement OTFS, techniques realized as an extension of orthogonal frequency division multiplexing (OFDM) have also been proposed (see U.S. Pat. No. 11,456,908, for example). Specifically, one OTFS block is generated from a plurality of OFDM symbols.

In OTFS modulation, information symbols mapped to resource elements are spread over a time-frequency domain. Specifically, in a frequency domain, information symbols are spread across the signal bandwidth, and in a time domain, information symbols are spread over the duration of a single subframe. Therefore, in OTFS modulation, it is possible to achieve a greater frequency diversity effect and a greater time diversity effect compared to OFDM modulation. In a high velocity movement environment where the influence of the Doppler effect is significant, OTFS modulation realizes a lower block error rate than OFDM modulation.

FIGS. 1A and 1B show an example of a system that is affected by a Doppler frequency.

According to FIG. 1A, the transmission station 1 is a base station fixed on the ground, and the receiving station 2 is a satellite in outer space. The satellite as viewed from the base station is moving at a high velocity, that is, a velocity v.

According to FIG. 1B, the transmission station 1 is a fixed base station, and the receiving station 2 is a railway vehicle. The railway vehicle as viewed from the base station is moving at a high velocity, that is, a velocity v.

For example, in the mobile communication frequency band of 3 to 7 GHz, communication between a fixed station and a mobile station such as a bullet train or an aircraft traveling at approximately 200 to 800 km/h is susceptible to degradation in communication rate due to the Doppler effect. To cope with such a communication environment, OTFS modulation can be applied.

As described above, when the influence of the Doppler effect is significant, OTFS modulation can be applied.

However, there is an issue that OTFS modulation increases power consumption. For example, in OTFS modulation, an amount of computation per bit symbol during transmission and reception is as large as the cube of that of OFDM modulation. Accordingly, power consumption is also high.

That is to say, when the influence of the Doppler effect is small, it can be said that applying OFDM modulation rather than OTFS modulation results in a smaller amount of computation, suppressed power consumption, and a higher communication capacity.

### SUMMARY OF THE INVENTION

The present invention provides a transmission station and a receiving station that can switch between OTFS modulation and OFDM modulation in accordance with the influence of the Doppler effect.

According to the present invention, a transmission station that performs wireless communication with a receiving station at a predetermined carrier frequency, including: an orthogonal frequency division multiplexing unit configured to perform orthogonal frequency division multiplexing on a symbol sequence; an orthogonal time frequency space multiplexing unit configured to perform orthogonal time frequency space multiplexing on a symbol sequence; a switching unit configured to switch between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit; a velocity obtaining unit configured to obtain a relative velocity between the transmission station and a receiving station; a switching control unit configured to control the switching unit based on a velocity; and a switching notification unit configured to transmit a switching notification that is a control signal to the receiving station, when the switching unit is controlled.

In the transmission station according to another aspect of the present invention, the switching control unit may control the switching unit using a switching control table in which the orthogonal frequency division multiplexing unit or the orthogonal time frequency space multiplexing unit is associated with each velocity in advance.

In the transmission station according to another aspect of the present invention, the velocity obtaining unit may store in advance a velocity table defining, for each clock time, a relative velocity of the receiving station as viewed from the transmission station, and obtain a velocity in accordance with a clock time by referring to the velocity table.

In the transmission station according to another aspect of the present invention, the velocity obtaining unit may receive a velocity and a direction of movement from the receiving station, and estimate a relative velocity of the receiving station as viewed from the transmission station based on displacement per unit time in terms of a distance and angle between the transmission station and the receiving station.

In the transmission station according to another aspect of the present invention, the velocity obtaining unit may periodically receive position information from the receiving station, and estimate a relative velocity of the receiving station as viewed from the transmission station based on displacement per unit time in terms of a distance and angle between the transmission station and the receiving station.

In the transmission station according to another aspect of the present invention, one of the transmission station and the receiving station may be a fixed station, and the other may be a mobile station.

In the transmission station according to another aspect of the present invention, a clock time synchronization unit configured to synchronize a clock time with the receiving station may be further provided, and the switching control unit may switch between the orthogonal frequency division multiplexing unit and the orthogonal time frequency space multiplexing unit in synchronization with the receiving station.

In the transmission station according to another aspect of the present invention, a Doppler frequency estimation unit configured to estimate a Doppler frequency based on a velocity is further provided, the switching control unit may cause the switching unit to: switch to the orthogonal frequency division multiplexing unit if a Doppler frequency is lower than or equal to a predetermined threshold, and switch to the orthogonal time frequency space multiplexing unit if the Doppler frequency is higher than the predetermined threshold.

In the transmission station according to another aspect of the present invention, the switching control unit may set, in advance through simulation, a predetermined threshold for a Doppler frequency at which a channel capacity per symbol in an orthogonal time frequency space multiplexing signal exceeds a channel capacity per symbol in an orthogonal frequency division multiplexing signal.

In the transmission station according to another aspect of the present invention, wherein the switching control unit may set a predetermined threshold for a Doppler frequency in advance through simulation such that one of the orthogonal frequency division multiplexing unit and the orthogonal time frequency space multiplexing unit for which the channel capacity is at least three times the other is selected.

In the transmission station according to another aspect of the present invention, the Doppler frequency estimation unit estimates a Doppler frequency as follows:

$${f}^{′} = fc \cdot v \cdot k$$

f: Doppler frequency
fc: carrier frequency
v: velocity
k: coefficient

In the transmission station according to another aspect of the present invention, the orthogonal frequency division multiplexing unit may be constituted by an inverse fast Fourier transform unit configured to perform conversion into a time domain signal, and the orthogonal time frequency space multiplexing unit may be constituted by an inverse symplectic fast Fourier transform unit configured to perform conversion into a time-frequency domain signal, and the inverse fast Fourier transform unit.

According to the present invention, a transmission station that performs wireless communication with a receiving station at a predetermined carrier frequency, including: an orthogonal frequency division multiplexing unit configured to perform orthogonal frequency division multiplexing on a symbol sequence; an orthogonal time frequency space multiplexing unit configured to perform orthogonal time frequency space multiplexing on a symbol sequence; a switching unit configured to switch between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit; a Doppler frequency estimation unit configured to receive a reference signal from the receiving station, and estimating a Doppler frequency based on displacement in terms of an amplitude and phase in the reference signal; a switching control unit configured to control the switching unit based on the Doppler frequency; and a switching notification unit configured to transmit a switching notification that is a control signal to the receiving station, when the switching unit is controlled.

According to the present invention, a receiving station that performs wireless communication with a transmission station at a predetermined carrier frequency, including: an orthogonal frequency division multiplexing unit configured to perform orthogonal frequency division multiplexing on a symbol sequence; an orthogonal time frequency space multiplexing unit configured to perform orthogonal time frequency space multiplexing on a symbol sequence; a switching unit configured to switch between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit; a velocity obtaining unit configured to obtain a relative velocity between the receiving station and the transmission station; a switching control unit configured to control the switching unit based on a velocity; and a switching notification unit configured to transmit a switching notification that is a control signal to the transmission station, when the switching unit is controlled.

According to the present invention, a receiving station that performs wireless communication with a transmission station at a predetermined carrier frequency, including: an orthogonal frequency division multiplexing unit configured to perform orthogonal frequency division multiplexing on a symbol sequence; an orthogonal time frequency space multiplexing unit configured to perform orthogonal time frequency space multiplexing on a symbol sequence; a switching unit configured to switching between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit; a Doppler frequency estimation unit configured to receive a reference signal from the transmission station, and estimating a Doppler frequency based on displacement in terms of an amplitude and phase in the reference signal; a switching control unit configured to control the switching unit based on the Doppler frequency; and a switching notification unit configured to transmit a switching notification that is a control signal to the transmission station, when the switching unit is controlled.

Further features of the present invention will become apparent from the following description of exemplary embodiments with reference to the attached drawings.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A shows an example of a system that is affected by a Doppler frequency;

FIG. 1B shows an example of a system that is affected by a Doppler frequency;

FIG. 2 is a functional configuration diagram of a transmission station that takes the initiative in switching according to the present invention;

FIG. 3 is an explanatory diagram of switching control according to the present invention;

FIG. 4 is a sequence diagram of a sequence performed between the transmission station and a receiving station according to the present invention;

FIG. 5 is a functional configuration diagram of the transmission station that estimates a Doppler frequency based on a reference signal;

FIG. 6 is a functional configuration diagram of the receiving station that faces the transmission station in FIG. 2; and

FIG. 7 is a functional configuration diagram of the receiving station that takes the initiative in switching according to the present invention.

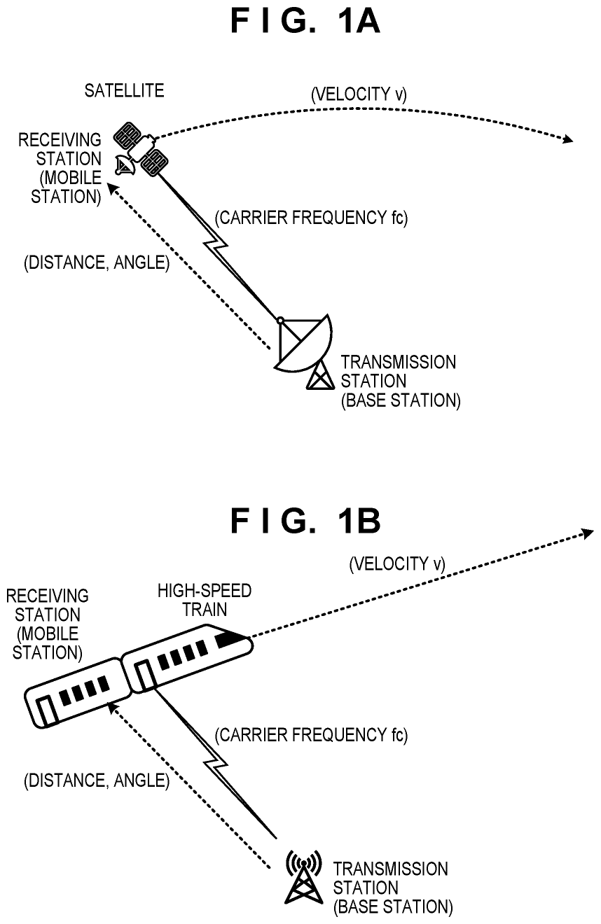

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

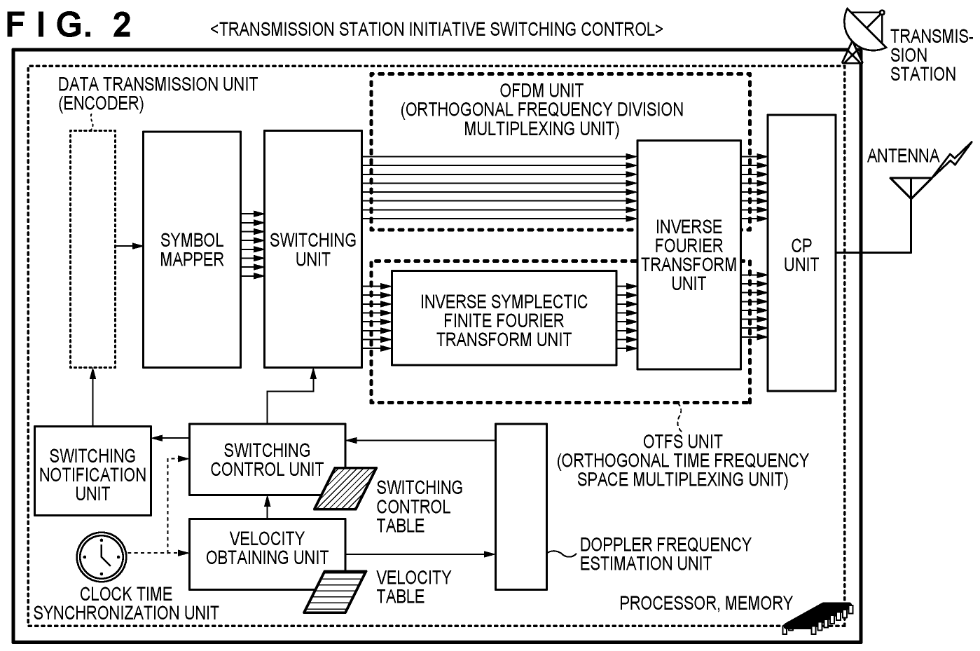

FIG. 2 is a functional configuration diagram of a transmission station that takes the initiative in switching according to the present invention.

Commonly, a communication method is controlled by a base station. Here, assume that a transmission station 1 is a fixed station serving as a base station, and a receiving station 2 is a mobile station.

According to FIG. 2, the transmission station 1 includes a symbol mapper 101, a cyclic prefix (CP) unit 102, an OFDM unit 11, an OTFS unit 12, a switching unit 13, a velocity obtaining unit 14, a switching control unit 15, a Doppler frequency estimation unit 16, a clock time synchronization unit 17, and a switching notification unit 18. These functional components are realized by executing a program for causing a modem chip (computer) installed on the transmission station to function. In addition, processing flows of these functional components can also be understood as transmission methods performed by the modem chip.

### Transmission Station 1

### Symbol Mapper 101

The symbol mapper 101 converts the bitstream of transmission data into N symbol sequences mapped onto a complex (IQ) plane that complies with a modulation scheme. For example, in the case of 64-quadrature amplitude modulation (QAM), the bitstream is divided into 6 bit units and mapped at 64 points on the complex plane. The horizontal axis of the complex plane represents a real part in amplitude units, and the vertical axis represents an imaginary part in amplitude units. The symbol sequences obtained through conversion are output to the switching unit 13.

### Switching Unit 13

The switching unit 13 switches between the OFDM unit 11 and the OTFS unit 12 to input symbol sequences to only one of the OFDM unit 11 and the OTFS unit 12. This switching is performed under the control of the switching control unit 15.

### OFDM Unit 11

The OFDM unit 11 performs orthogonal frequency division multiplexing (OFDM) on symbol sequences. The OFDM unit 11 is constituted by an inverse fast Fourier transform (IFFT) unit 110 that performs conversion into time domain signals. The inverse fast Fourier transform unit 110 performs conversion into sine waves in 6 bit units, for example.

### OTFS Unit 12

The OTFS unit 12 performs orthogonal time frequency space multiplexing on symbol sequences. The OTFS unit 12 is constituted by an inverse symplectic fast Fourier transform (ISFFT) unit 120 that performs conversion into time-frequency domain signals, and the inverse fast Fourier transform unit 110. The OTFS unit 12 may be implemented as an extension of the OFDM unit 11 (for example, see U.S. Pat. No. 11,456,908).

### CP Unit 102

The CP unit 102 adds a redundant signal (cyclic prefix) to the beginning of a symbol input from either the OFDM unit 11 or the OTFS unit 12. Specifically, data for a certain period of time from the rear end of the symbol is inserted at the beginning of the symbol as a cyclic prefix. This suppresses inter-symbol interference and inter-carrier interference.

An output signal from the CP unit 102 undergoes D/A conversion performed by a digital analog converter and is then transmitted from an antenna.

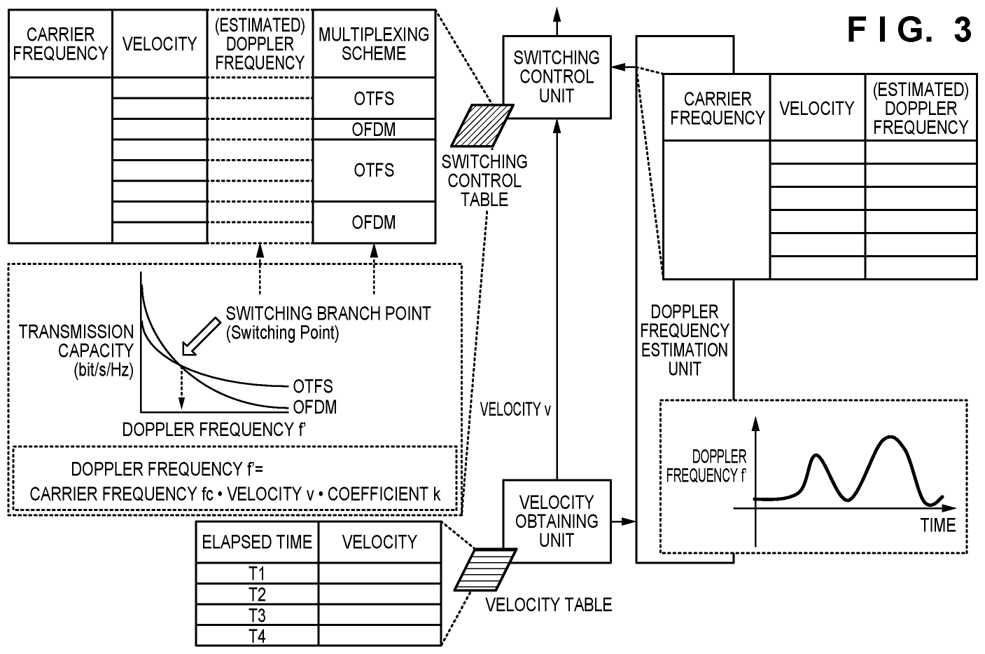

FIG. 3 is an explanatory diagram of switching control according to the present invention.

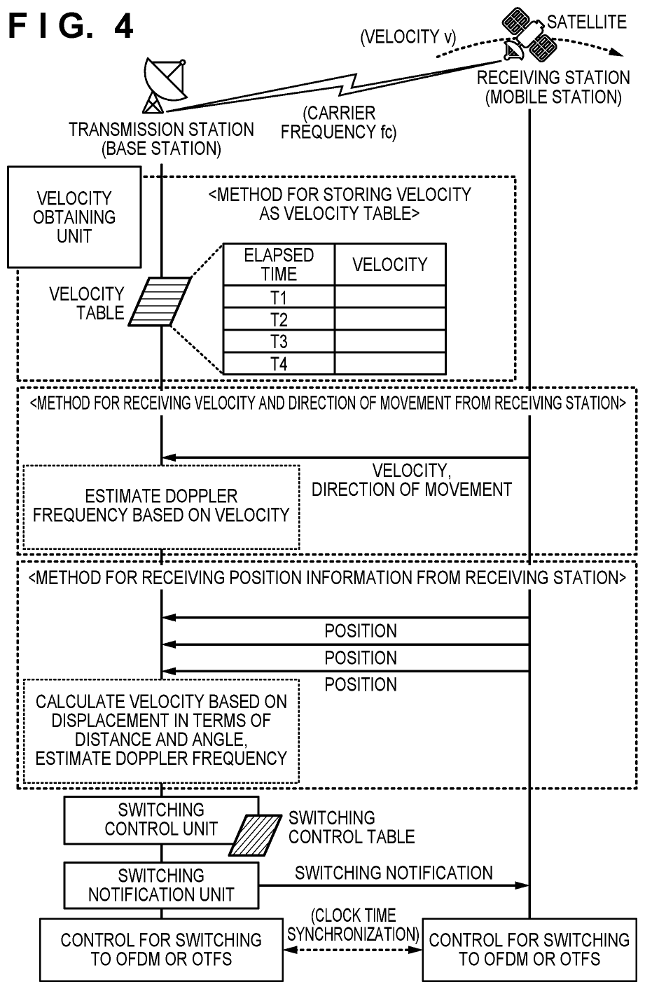

FIG. 4 is a sequence diagram of a sequence performed between a transmission station and a receiving station according to the present invention.

### Velocity Obtaining Unit 14

The velocity obtaining unit 14 obtains a relative velocity of the receiving station 2. For example, there are the following three methods:
a method for storing a velocity as a velocity table,
a method for receiving a velocity and a direction of movement from the receiving station, and
a method for receiving position information from the receiving station

### Method for Storing Velocity as Velocity Table (see S141 in FIG. 4)

The velocity obtaining unit 14 stores in advance a “velocity table” defining, for each clock time, a relative velocity of the receiving station 2 as viewed from the transmission station 1. Accordingly, a velocity can be obtained in accordance with a clock time by referring to the velocity table.

For example, in a case of a medium Earth orbit or low Earth orbit satellite that moves periodically, or a high-speed train such as a bullet train that moves based on a timetable, the position thereof can be specified based on a clock time of the day, and a velocity thereof as seen from the transmission station 1 can also be specified in advance. It is also possible to estimate a Doppler frequency based on the specified velocity. For this reason, a velocity can be defined in a table in association with each clock time.

For example, envision a case where the transmission station 1 is a terrestrial fixed station on the Earth, and the receiving station 2 is a satellite. The transmission station 1, which is a terrestrial fixed station, is rotating at 1,700 km/h as the Earth, while the receiving station 2, which is a satellite, is moving at 7 to 8 km/h at an altitude of 500 km above the Earth's surface (low Earth orbit satellite). The distance between the transmission station 1 and the receiving station 2 changes depending on the angle at which the receiving station 2 is seen from the transmission station 1, and the velocity also changes accordingly.

Method for Receiving Velocity and Direction of Movement from Receiving Station (see S142 in FIG. 4)

The velocity obtaining unit 14 receives a velocity and a direction of movement as control information from the receiving station 2. Accordingly, a relative velocity can be estimated based on the moving locus that represents displacement per unit time in terms of the distance and angle between the transmission station 1 and the receiving station 2 as viewed from the transmission station 1.

Method for Receiving Position Information from Receiving Station (see S143 in FIG. 4)

The velocity obtaining unit 14 periodically receives position information (latitude, longitude, and altitude) as control information from the receiving station 2, and can thereby estimate a relative velocity based on the moving locus, which represents displacement per unit time in terms of the distance and angle between the transmission station 1 and the receiving station 2 as seen from the transmission station 1.

### Clock Time Synchronization Unit 17 GNSS

The clock time synchronization unit 17 accurately synchronizes the clock time with the receiving station 2. Specifically, the clock time synchronization unit 17 generates a coordinated universal time (UTC) by receiving radio waves of the global navigation satellite system (GNSS) protocol or the like. Alternatively, a protocol such as the simple network time protocol (SNTP), the network time protocol (NTP), or the precision time protocol (PTP) may be used.

By accurately synchronizing the clock time between the transmission station 1 and the receiving station 2, the switching control unit 15 synchronizes switching between the OFDM unit 11 and the OTFS unit 12 with the receiving station 2. In addition, the velocity obtaining unit 14 can accurately derive the velocity of the receiving station 2 in accordance with the clock time.

### Doppler Frequency Estimation Unit 16

The Doppler frequency estimation unit 16 estimates a Doppler frequency based on the velocity. Specifically, the Doppler frequency estimation unit 16 estimates the maximum Doppler frequency as follows:

$${f}^{′} = fc \cdot v \cdot k$$

f: maximum Doppler frequency
fc: carrier frequency
v: velocity
k: coefficient

Here, the coefficient k is calculated as follows:

$$k = cos θ / c$$

θ: receiving angle of radio waves (the angle of the mobile station as viewed from the fixed station)
c: light speed

### Switching Control Unit 15

The switching control unit 15 controls the switching unit 13 using the following two methods:
switching control based on a velocity using a velocity table, and
switching control based on an estimated Doppler frequency

### Switching Control Based on Velocity Using Velocity Table

The switching control unit 15 has a switching control table in which the OFDM unit 11 or the OTFS unit 12 is associated with each velocity in advance. The switching control unit 15 controls the switching unit 13 in accordance with a velocity input from the velocity obtaining unit 14 by referring to the switching control table.

Here, the switching control table of the switching control unit 15 is defined so as to estimate a Doppler frequency based on a velocity, and to switch to the OFDM unit 11 or the OTFS unit 12 in accordance with the estimated Doppler frequency.

Here, content in the switching control table differs depending on the carrier frequency fc. If the carrier frequency is constant, the Doppler frequency f increases as the velocity v increases. On the other hand, even if the velocity v is constant, the Doppler frequency f increases as the carrier frequency fc increases.

The switching control unit 15 causes the switching unit 13 to perform switching as follows in accordance with the Doppler frequency.
switch to the OFDM unit 11 if the Doppler frequency is lower than or equal to a predetermined threshold
switch to the OTFS unit 12 if the Doppler frequency is higher than the predetermined threshold

Here, the predetermined threshold for Doppler frequency is set in advance through simulation.

The switching control unit 15 sets a Doppler frequency at which a channel capacity per symbol in the OTFS unit 12 exceeds a channel capacity per symbol in the OFDM unit 11. Specifically, the switching control unit 15 may set, in advance through simulation, a predetermined threshold for Doppler frequency such that one of the OFDM unit 11 and the OTFS unit 12 for which the channel capacity is at least three times the other is selected.

### Switching Control Using Estimated Doppler Frequency

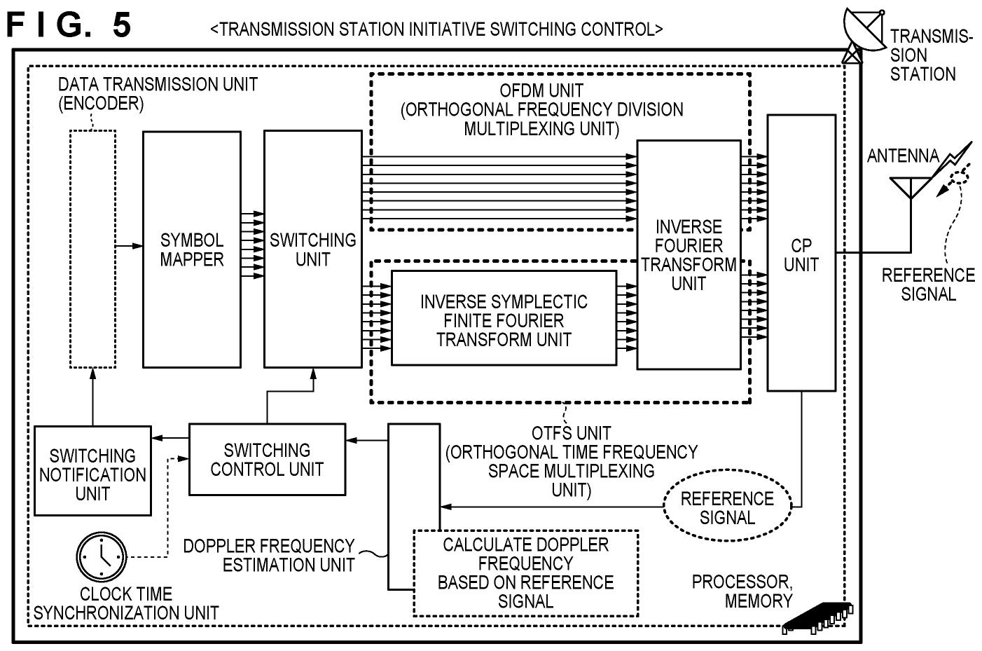

FIG. 5 is a functional configuration diagram of the transmission station that estimates a Doppler frequency based on a reference signal.

According to FIG. 5, unlike FIG. 2, the transmission station 1 receive a reference signal from the receiving station 2. The Doppler frequency estimation unit 16 of the transmission station 1 can then estimate a Doppler frequency based on displacement in terms of the amplitude and phase (e.g., phase rotation) in the reference signal (for example, see Tao Liao et al, “Study on Doppler Frequency Offset Estimation Algorithm for High Speed Maglev”). In this case, compared to the aforementioned switching control based on a velocity using the velocity table, measurement of a Doppler frequency requires a longer time.

Accordingly, the switching control unit 15 compares the Doppler frequency with the predetermined threshold, and switches to the OFDM unit 11 or the OTFS unit 12.

### Switching Notification Unit 18

When the switching unit 13 is controlled, the switching notification unit 18 transmits a switching notification that is a control signal to the receiving station 2. Accordingly, the transmission station 1 and the receiving station 2 can synchronize switching between the OFDM unit 11 and the OTFS unit 12 with each other.

### Receiving Station 2

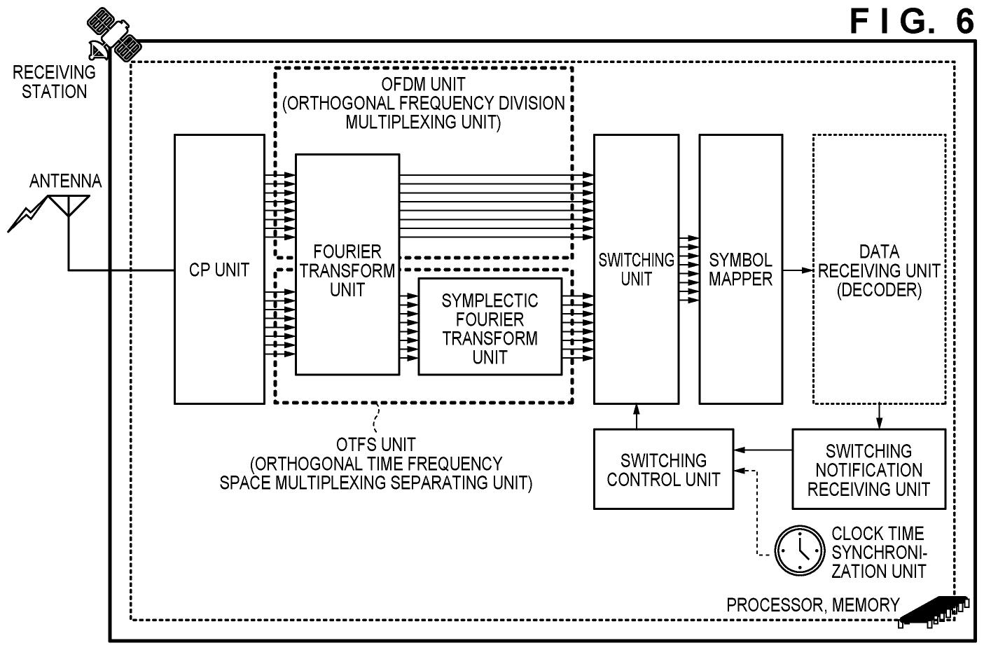

FIG. 6 is a functional configuration diagram of the receiving station that faces the transmission station in FIG. 2.

According to FIG. 6, the receiving station 2 includes a symbol demapper 201, a CP unit 202, an OFDM unit 21, an OTFS unit 22, the switching unit 23, a velocity obtaining unit 24, and a switching control unit 25. These functional components are realized by executing a program for causing a modem chip (computer) installed on the receiving station to function. In addition, processing flows of these functional components can also be understood as receiving methods performed by the modem chip.

According to FIG. 6, the receiving station 2 receives a switching notification transmitted from the transmission station 1 using a switching notification receiving unit 29. In the switching notification, the OFDM unit 21 or the OTFS unit 22 that is a switching destination is designated, and a switching timing is also designated. Accordingly, the switching control unit 25 can switch to the OFDM unit 21 or the OTFS unit 22 in synchronization with the transmission station 1.

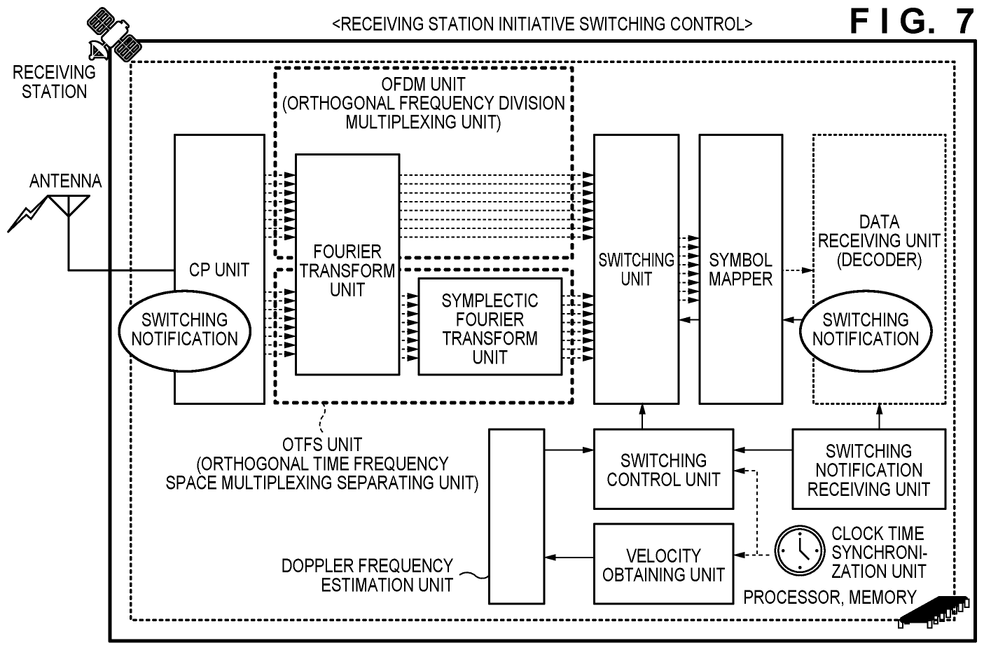

FIG. 7 is a functional configuration diagram of the receiving station that takes the initiative in switching according to the present invention.

FIG. 7 shows switching in which the receiving station takes the initiative in contrast with switching in which the transmission station takes the initiative in FIG. 2. Processing performed by the functional components are exactly the same as that in FIG. 2.

Note that, when a reference signal is received from the transmission station 1, a Doppler frequency estimation unit 26 of the receiving station 2 can also estimate a Doppler frequency based on displacement in terms of an amplitude and phase in the reference signal. Moreover, the switching unit 23 can be controlled based on the Doppler frequency.

Note that, according to the above embodiment, description has been given in which the transmission station 1 is a fixed station, and the receiving station 2 is a mobile station. As a matter of course, there is no limitation thereto, and a configuration may be adopted in which the transmission station 1 is a mobile station, and the receiving station 2 is a fixed station. In addition, both the transmission station 1 and the receiving station 2 may be a mobile station, and it is sufficient that a relative velocity can be obtained.

As described above in detail, with the transmission station and the receiving station according to the present invention, it is possible to switch between OTFS modulation and OFDM modulation in accordance with the influence of a Doppler frequency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The invention is not limited to the foregoing embodiments, and various variations/changes are possible within the spirit of the invention.

What is claimed is:

1. A transmission station that performs wireless communication with a receiving station at a predetermined carrier frequency, comprising:
an orthogonal frequency division multiplexing unit configured to perform orthogonal frequency division multiplexing on a symbol sequence;
an orthogonal time frequency space multiplexing unit configured to perform orthogonal time frequency space multiplexing on a symbol sequence;
a switching unit configured to switch between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit;
a velocity obtaining unit configured to obtain a relative velocity between the transmission station and a receiving station;
a switching control unit configured to control the switching unit based on a velocity; and
a switching notification unit configured to transmit a switching notification that is a control signal to the receiving station, when the switching unit is controlled.

2. The transmission station according to claim 1, wherein
the switching control unit controls the switching unit using a switching control table in which the orthogonal frequency division multiplexing unit or the orthogonal time frequency space multiplexing unit is associated with each velocity in advance.

3. The transmission station according to claim 1, wherein
the velocity obtaining unit stores in advance a velocity table defining, for each clock time, a relative velocity of the receiving station as viewed from the transmission station, and
obtains a velocity in accordance with a clock time by referring to the velocity table.

4. The transmission station according to claim 1, wherein
the velocity obtaining unit receives a velocity and a direction of movement from the receiving station, and estimates a relative velocity of the receiving station as viewed from the transmission station based on displacement per unit time in terms of a distance and angle between the transmission station and the receiving station.

5. The transmission station according to claim 1, wherein
the velocity obtaining unit periodically receives position information from the receiving station, and estimates a relative velocity of the receiving station as viewed from the transmission station based on displacement per unit time in terms of a distance and angle between the transmission station and the receiving station.

6. The transmission station according to claim 1, wherein
one of the transmission station and the receiving station is a fixed station, and the other is a mobile station.

7. The transmission station according to claim 1, further comprising
a clock time synchronization unit configured to synchronize a clock time with the receiving station, wherein
the switching control unit switches between the orthogonal frequency division multiplexing unit and the orthogonal time frequency space multiplexing unit in synchronization with the receiving station.

8. The transmission station according to claim 1, further comprising
a Doppler frequency estimation unit configured to estimate a Doppler frequency based on a velocity, wherein
the switching control unit causes the switching unit to:
switch to the orthogonal frequency division multiplexing unit if a Doppler frequency is lower than or equal to a predetermined threshold, and
switch to the orthogonal time frequency space multiplexing unit if the Doppler frequency is higher than the predetermined threshold.

9. The transmission station according to claim 8, wherein
the switching control unit sets, in advance through simulation, a predetermined threshold for a Doppler frequency at which a channel capacity per symbol in an orthogonal time frequency space multiplexing signal exceeds a channel capacity per symbol in an orthogonal frequency division multiplexing signal.

10. The transmission station according to claim 9, wherein
the switching control unit sets a predetermined threshold for a Doppler frequency in advance through simulation such that one of the orthogonal frequency division multiplexing unit and the orthogonal time frequency space multiplexing unit for which the channel capacity is at least three times the other is selected.

11. The transmission station according to claim 8, wherein
the Doppler frequency estimation unit estimates a Doppler frequency as follows:
$${f}^{′} = fc \cdot v \cdot k$$
f: Doppler frequency
fc: carrier frequency
v: velocity
k: coefficient

12. The transmission station according to claim 1, wherein
the orthogonal frequency division multiplexing unit is constituted by an inverse fast Fourier transform unit configured to perform conversion into a time domain signal, and
the orthogonal time frequency space multiplexing unit is constituted by an inverse symplectic fast Fourier transform unit configured to perform conversion into a time-frequency domain signal and the inverse fast Fourier transform unit.

13. A transmission station that performs wireless communication with a receiving station at a predetermined carrier frequency, comprising:
an orthogonal frequency division multiplexing unit configured to perform orthogonal frequency division multiplexing on a symbol sequence;
a orthogonal time frequency space multiplexing unit configured to perform orthogonal time frequency space multiplexing on a symbol sequence;
a switching unit configured to switch between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit;
a Doppler frequency estimation unit configured to receive a reference signal from the receiving station, and estimating a Doppler frequency based on displacement in terms of an amplitude and phase in the reference signal;
a switching control unit configured to control the switching unit based on the Doppler frequency; and
a switching notification unit configured to transmit a switching notification that is a control signal to the receiving station, when the switching unit is controlled.

14. A receiving station that performs wireless communication with a transmission station at a predetermined carrier frequency, comprising:
an orthogonal frequency division multiplexing unit configured to perform orthogonal frequency division multiplexing on a symbol sequence;
an orthogonal time frequency space multiplexing unit configured to perform orthogonal time frequency space multiplexing on a symbol sequence;
a switching unit configured to switch between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit;
a velocity obtaining unit configured to obtain a relative velocity between the receiving station and the transmission station;
a switching control unit configured to control the switching unit based on a velocity; and
a switching notification unit configured to transmit a switching notification that is a control signal to the transmission station, when the switching unit is controlled.

15. A receiving station that performs wireless communication with a transmission station at a predetermined carrier frequency, comprising:
an orthogonal frequency division multiplexing unit configured to perform orthogonal frequency division multiplexing on a symbol sequence;
an orthogonal time frequency space multiplexing unit configured to perform orthogonal time frequency space multiplexing on a symbol sequence;
a switching unit configured to switch between the orthogonal frequency division multiplexing unit and the orthogonal time frequency space multiplexing unit to input a symbol sequence obtained by mapping a bitstream, to only one of the orthogonal frequency division multiplexing unit and the orthogonal time frequency space multiplexing unit;
a Doppler frequency estimation unit configured to receive a reference signal from the transmission station, and estimating a Doppler frequency based on displacement in terms of an amplitude and phase in the reference signal;
a switching control unit configured to control the switching unit based on the Doppler frequency; and
a switching notification unit configured to transmit a switching notification that is a control signal to the transmission station, when the switching unit is controlled.
